(19) United States
(12) Patent Application Publication
(10) Pub. No.: US 2004/0037631 A1
(43) Pub. Date: Feb. 26, 2004

(54) Cast fixing element for a wiper arm

(76) Inventor: Josef Vermeulen, Herk-de-Stad (DE)

Correspondence Address: Striker Striker & Stenby, 103 East Neck Road, Huntington, NY, 11743, US

(21) Appl. No.: 10/416,666

(22) PCT Filed: Jul. 6, 2001
(86) PCT No.: PCT/DE01/02454

(51) Int. Cl. F16D 1/00

(52) U.S. Cl. 403/315

(57) ABSTRACT

The object is to make a cast fastener (10) for a wiper arm, having a though opening (14) for a bearing bush and a receptacle for a retaining pin (16), that can be produced at less expense. For this purpose, it is provided that the receptacle for the retaining pin is a groove (30), which is closed on its face ends.

### PRIOR ART

The invention relates to a cast fastener for a wiper arm, with a though opening for a bearing bush and with a receptacle for a retaining pin.

A fastener of this kind serves to connect a wiper arm to a drive motor. The wiper arm is supported rotatably on the bearing bush, and a tension spring that presses the wiper arm against the window to be cleaned is suspended from the retaining pin.

Until now, the fastener, which is a cast part, was drilled after casting, in order to obtain a through bore for the bearing bush and another bore for receiving the retaining pin. A disadvantage of this production process is the major effort and expense associated on the one hand with the metal-cutting machining of the fastener and on the other with maintaining the requisite tolerances for the two bores.

It is therefore the object of the invention to furnish a fastener that can be produced at less expense.

### ADVANTAGES OF THE INVENTION

The fastener having the characteristics of claim 1 has the advantage of not requiring metal-cutting machining to create the receptacle for the retaining pin. The groove serving as a receptacle is created in the casting process. The retaining pin need merely be placed later in the groove and calked in it. The further advantage is obtained that during the production process itself, no effort or expense whatever is needed to maintain the specified tolerances; the location of the groove is taken into account with the requisite precision in the production of the casting mold and is then reproduced upon every copy-molding process.

According to a preferred embodiment of the invention, it is provided that the surface of the though opening is produced by direct copy-molding of a casting mold. Thus for producing the though opening as well, metal-cutting machining is no longer needed, and the same advantages result as when metal-cutting machining is dispensed for the receptacle for the retaining pin.

Advantageous features of the invention are defined by the dependent claims.

### DRAWINGS

The invention will be described below in terms of a preferred embodiment that is shown in the accompanying drawings. Shown in the drawings are:

FIG. 1, a complete wiper arm from below;

FIG. 2, the wiper arm of FIG. 1 in a side view;

FIG. 3, the fastener, used in the wiper arm of FIG. 2, in a fragmentary view, partly in section;

FIG. 4, the fastener of FIG. 3 seen from below; and

FIG. 5, in an enlarged elevation view, a section through the fastener taken along the plane V-V of FIG. 3.

### DESCRIPTION OF THE EXEMPLARY EMBODIMENT

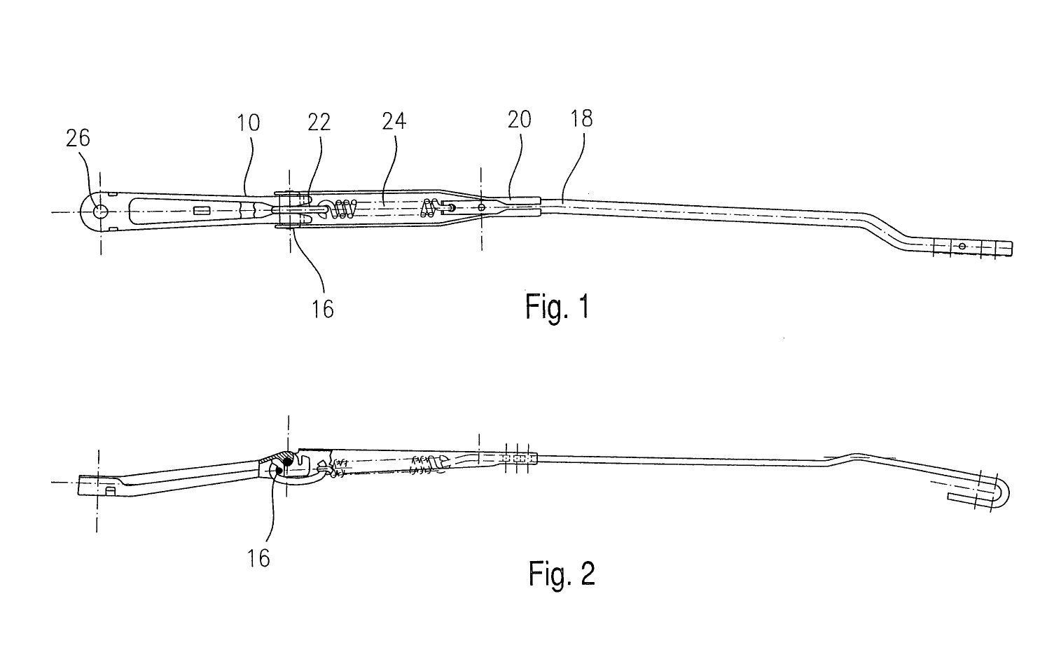

In FIGS. 1 and 2, a wiper arm is shown which comprises a fastener 10, a sheet-metal part 20, and a cantilevered arm 18 joined solidly to the sheet-metal part.

The fastener 10 has a receiving bore 26, by means of which it can be connected to a wiper drive mechanism (not shown). The sheet-metal part 20 is secured to the fastener 10 rotatably by means of a bearing bush 28 which is inserted into a though opening 14. A tension spring 22 is mounted on the sheet-metal part and suspended from a retaining pin 16 on the fastener and serves to press the wiper blade, via the cantilevered arm, against a window to be cleaned.

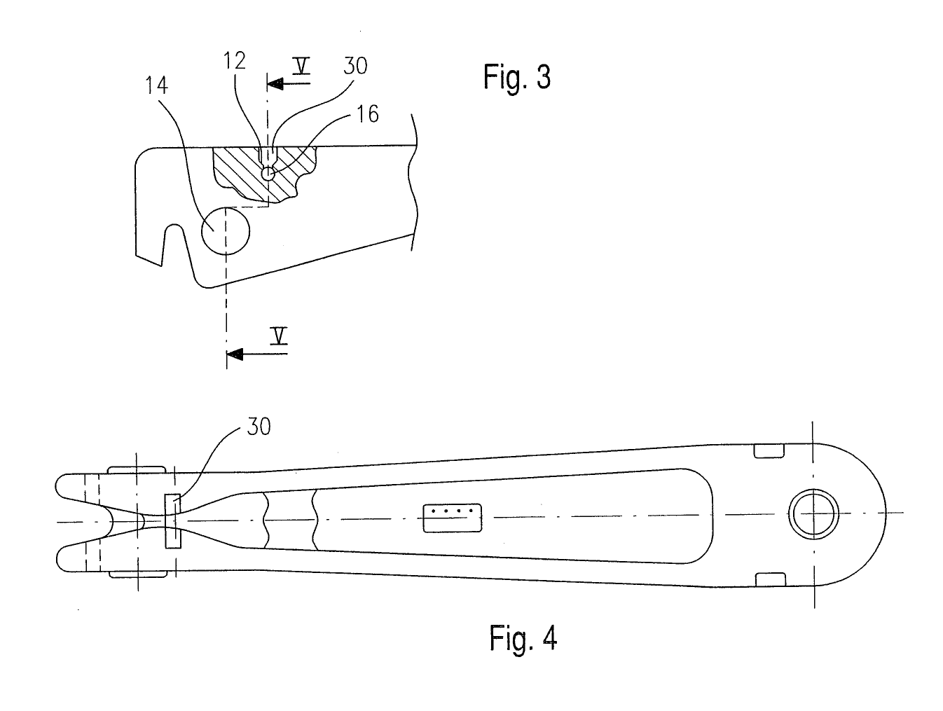

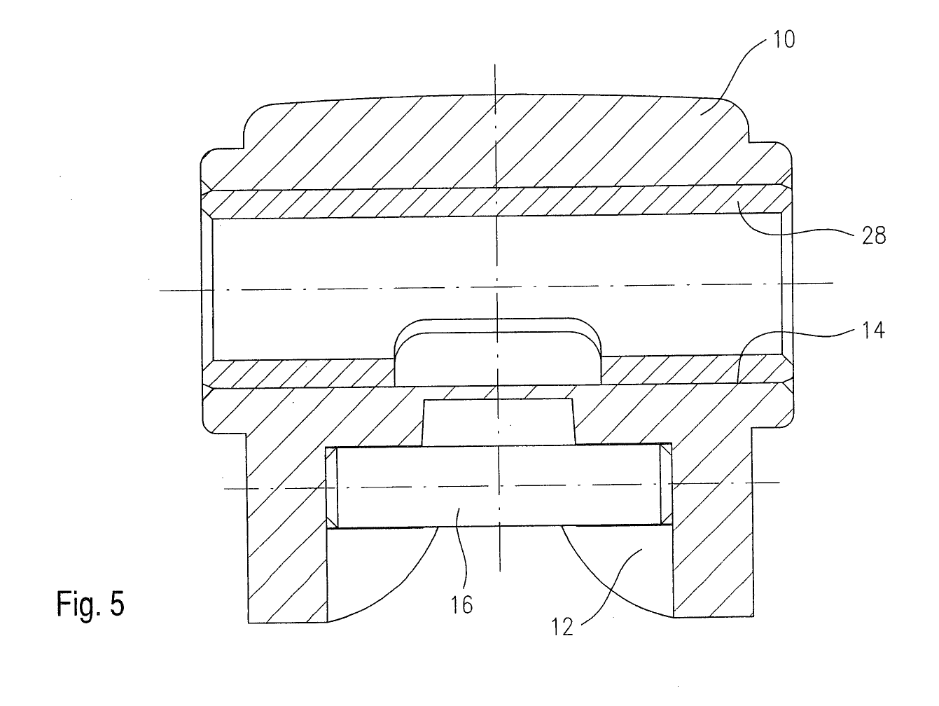

In conjunction with FIGS. 3-5, the fastener, which is a cast part, will now be described in further detail. The though opening 14 is created by copy-molding of a suitable portion of the casting mold in which the fastener is cast. In this way, the requisite tolerances can be maintained directly, so that no postmachining is needed, and the bearing bush 28 can be press-fitted directly into the though opening.

The retaining pin 16 is disposed in a groove 30, which is closed on both ends in the axial direction. This groove as well is created by copy-molding of a suitable portion of the casting mold, so that no postmachining is required. The retaining pin is then placed in the groove 30; it cannot slip in the axial direction, since the groove is closed. Next, the fastener 10 is deformed in the region of the groove via a deforming die (not shown) in such a way that at least one lug 12 is created, which securely keeps the retaining pin 16 in its position. This calking of the retaining pin offers an extremely effective securing of the retaining pin to the fastener 10 and furthermore can be accomplished with little effort or expense in terms of machinery.

List of Reference Numerals

| | |
|---|---|
| 10: | Fastener |
| 12: | Lug |
| 14: | Though opening |
| 16: | Retaining pin |
| 18: | Cantilevered arm |
| 20: | Sheet-metal part |
| 22: | Retaining bracket |
| 24: | Spring |
| 26: | Receiving bore |
| 28: | Bearing bush |
| 30: | Groove |

1. A cast fastener (10) for a wiper arm, having a though opening (14) for a bearing bush and a receptacle for a retaining pin (16), characterized in that the receptacle for the retaining pin is a groove (30) that is closed on its face ends.

2. The fastener of claim 1, characterized in that the retaining pin (16) is disposed in the groove, and that the fastener (10) is provided with lugs (12) that secure the retaining pin in the groove.

3. The fastener of claim 2, characterized in that the lugs (12) are embodied integrally with the fastener (10) and are obtained by means of plastic deformation of a peripheral portion of the groove.

4. The fastener of one of the foregoing claims, characterized in that it is a diecast part.

5. The fastener of claim 4, characterized in that the surface of the though opening (14) is produced by direct copy-molding of a casting mold.

6. The fastener of one of claims 4 and 5, characterized in that it comprises a zinc alloy.

7. The fastener of one of claims 4 and 5, characterized in that it comprises a aluminum alloy.
